(19) United States
(12) Patent Application Publication
(10) Pub. No.: US 2021/0073921 A1
(43) Pub. Date: Mar. 11, 2021

(54) EXPENSE REPORT REVIEWING INTERFACE

(71) Applicant: Oracle International Corporation, Redwood Shores, CA (US)

(72) Inventors: Winston Leonard Wang, San Francisco, CA (US); Parker Ralph Kuncl, Seattle, WA (US); Kelly Bailey, San Francisco, CA (US); Matthew Brigante, Seattle, WA (US)

(73) Assignee: Oracle International Corporation, Redwood Shores, CA (US)

(21) Appl. No.: 17/017,391

(22) Filed: Sep. 10, 2020

Related U.S. Application Data
(60) Provisional application No. 62/898,712, filed on Sep. 11, 2019.

(51) Int. Cl. G06Q 40/00; G06Q 30/02; G06Q 10/10; G06F 3/0484; G06N 20/00; G06N 5/04; G06T 11/00

(52) U.S. Cl. CPC G06Q 40/12; G06Q 30/0205; G06Q 10/105; G06Q 30/0185; G06N 20/00; G06N 5/04; G06T 11/00; G06F 3/04842

(57) ABSTRACT

Techniques for presenting an expense report reviewing interface are disclosed. An expense auditing system receives expense descriptions associated with expenses incurred by one or more employees. The expense auditing system determines associations between the expense descriptions and geographical locations where the expenses were incurred. The expense auditing system presents a graphical user interface that includes: (a) a geographical map representing the geographical locations where the expenses were incurred; and (b) an expense auditing overlay that, based at least on the associations between the expense descriptions and the geographical locations where the expenses were incurred, visually associates the expenses with corresponding locations on the geographical map.

### RELATED APPLICATIONS; INCORPORATION BY REFERENCE

This application claims the benefit of U.S. Provisional Patent Application 62/898,712, filed Sep. 11, 2019, which is hereby incorporated by reference.

This application is related to: U.S. Provisional Patent Application 62/898,695, titled “Expense Report Generation System”; U.S. Provisional Patent Application 62/898,699, titled “Real-Time Expense Auditing System”; U.S. Provisional Patent Application 62/898,705, titled “Expense Receipt Processing System”; U.S. Provisional Patent Application 62/898,718, titled “Expense Report Submission Interface”; and U.S. Provisional Patent Application 62/898,724, titled “Reimbursable Expense Recommendation System”. All of the aforementioned patent applications are hereby incorporated by reference.

### TECHNICAL FIELD

The present disclosure relates to applications and interfaces for optimizing management of expense data. In particular, the present disclosure relates to graphical user interface (GUI) applications and machine learning models to enhance expense processing.

### BACKGROUND

During the course of business-related activity (e.g., domestic or international travel, site visits and/or other kinds of business meetings, meals with customers and/or prospective customers, routine business operations, promotional events, and/or any other kind of business-related activity or combination thereof), employees sometimes incur expenses that are reimbursable by their employer as business expenses. To obtain reimbursement for such expenses, an employee typically submits an expense report. An expense report is a report that includes one or more expense descriptions. Each expense description includes expense data that describes one or more business expenses incurred by the employee. Expense data may include but is not limited to: a name of the employee that incurred the expense, a date the expense was incurred, a type of expense, a reason for the expense, an amount of the expense, a venue corresponding to the expense, a business project associated with the expense, a number of employees that benefited from the expense. An expense description template or expense report template may define a set of mandatory and/or non-mandatory fields to be filled out when preparing an expense description or expense report.

Businesses typically impose limits on reimbursable business expenses. Each expense limit may apply to an entire organization, a particular business unit, and/or one or more particular employees. Expense auditing is the process of determining, for each expense described in an expense report, whether the expense is approved for reimbursement.

Generating and/or auditing expense reports may be subject to various kinds of errors and inefficiencies. If an employee neglects to include an incurred expense in an expense report, the employee may end up paying for that expense out-of-pocket. If an employee is not aware of an opportunity for reimbursement, the employee may fail to take advantage of that expense opportunity. If an employee fails to properly manage spending, the employee may incur expenses that are partially or wholly non-reimbursable. Because preparing expense reports manually is time-consuming, an employee may delay preparing an expense report and subsequently forget to include reimbursable expenses in the expense report. Some employees may habitually overspend relative to an expense limit, while other employees may habitually underspend relative to the same expense limit. Some employees may include non-reimbursable expenses in expense reports. Habitual overspending, underspending, and/or non-reimbursable expense reporting may adversely affect organizational and/or individual expense budgets. In addition, depending on the number of employees submitting expense reports and/or the complexity of the organization's expense reimbursement rules, auditing expense reports may be time-consuming and error-prone. Generating and/or auditing expense reports may be subject to many other kinds of errors and inefficiencies.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

FIG. 1 illustrates a system in accordance with some embodiments;

FIGS. 2A-2B illustrate a set of operations for presenting expenses in a graphical user interface in accordance with some embodiments;

FIG. 3 illustrates a set of operations for adjusting expense limits in accordance with some embodiments;

FIG. 4 illustrates a set of operations for adjusting expense limits using machine learning in accordance with some embodiments;

FIGS. 5A-5C illustrate examples in accordance with some embodiments;

FIG. 6 shows a block diagram that illustrates a computer system in accordance with some embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. ARCHITECTURAL OVERVIEW
3. PRESENTING EXPENSES IN AN EXPENSE REPORT REVIEWING INTERFACE
4. ADJUSTING EXPENSE LIMITS
5. ADJUSTING EXPENSE LIMITS USING MACHINE LEARNING
6. ILLUSTRATIVE EXAMPLES
7. HARDWARE OVERVIEW
8. COMPUTER NETWORKS AND CLOUD NETWORKS
9. MICROSERVICE APPLICATIONS
10. MISCELLANEOUS; EXTENSIONS

### 1. GENERAL OVERVIEW

One or more embodiments facilitate the review of expense reports by generating and displaying a geographical view of expense data. The system presents expense data in a graphical user interface (GUI) that associates expenses with geographical locations where the expenses were incurred. The geographical view of expense data may help an auditor understand the context of a set of expenses and determine, in that context, whether expense descriptions should be approved or rejected.

One or more embodiments facilitate the review of expense reports by generating and displaying a timeline view of expense data on a geographical map. A timeline view adds expenses to a displayed geographical map one-at-a-time based on the chronological order in which the expenses were incurred. The system may pause the timeline and thereby pause the addition of expenses to the geographical map in response to detecting expenses that match a detailed review criteria.

One or more embodiments employ machine learning techniques to suggest and/or automatically perform adjustments to expense limits based on reviewer behavior. As an example, the system may train a model to learn patterns in expense attributes that consistently lead to an expense limit being overridden by a reviewer. Based on the pattern, the system may suggest modifying or automatically adjust the expense limit for expenses that match the particular set of attributes.

One or more embodiments display an expense reviewing interface that allows an administrator to globally modify expense policies and/or guidelines without affecting expense limits that are not adjustable in the manner requested.

One or more embodiments described in this Specification and/or recited in the claims may not be included in this General Overview section.

2. ARCHITECTURAL OVERVIEW

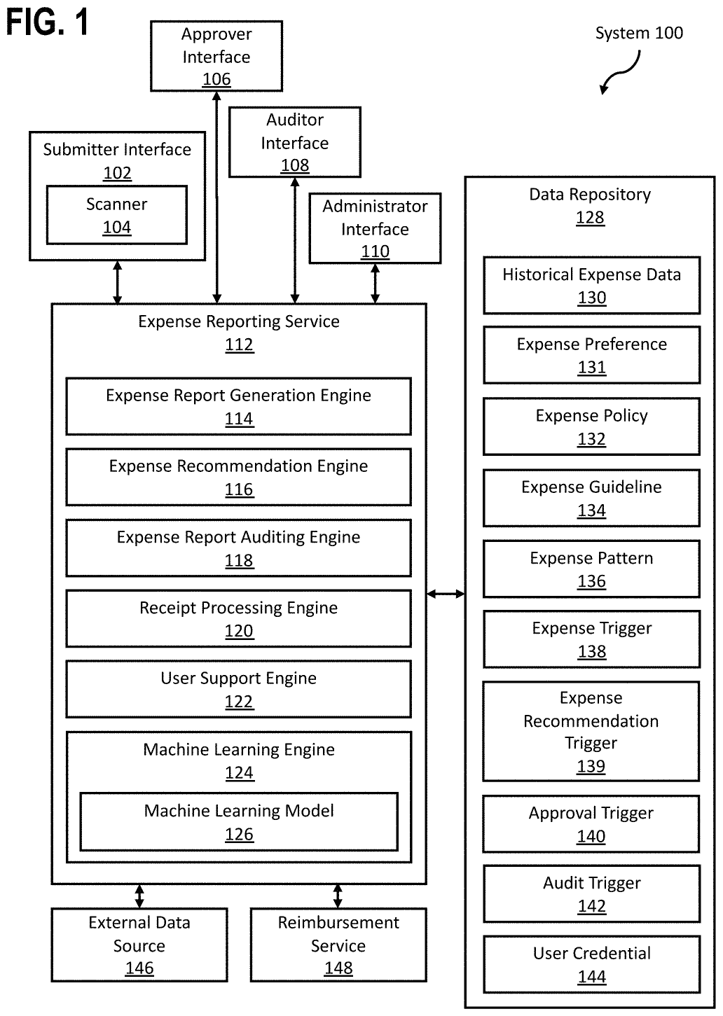

FIG. 1 illustrates a system 100 in accordance with some embodiments. As illustrated in FIG. 1, system 100 includes a submitter interface 102, an approver interface 106, an auditor interface 108, an administrator interface 110, an expense reporting service 112, a data repository 128, an external data source 146, a reimbursement service 148, and various components thereof. In some embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component. Additional embodiments and/or examples relating to computer networks are described below.

In some embodiments, each of submitter interface 102, approver interface 106, auditor interface 108, and administrator interface 110 refers to hardware and/or software configured to facilitate communications between a user and an expense reporting service 112. A submitter interface 102 may be used by a user, such as an employee, who is responsible for preparing and submitting expense descriptions and/or expense reports. The submitter interface 102 may be associated with one or more devices for obtaining visual media that represents a receipt for an expense, such as a scanner 104, a camera, a video device, or any other kind of device configured to capture visual media. An approver interface 106 may be used by a user, such as an employee in a managerial role, who is responsible for approving expense reports prior to submission for reimbursement. In some embodiments, expense reports are not subject to managerial approval prior to submission for reimbursement. An auditor interface 108 may be used by a user, such as an employee in an auditor role, who is responsible for auditing expense reports. An administrator interface 110 may be used by a user, such as an employee in an administrative role, who is responsible for determining and/or configuring parameters, rules, etc., that are used by an expense reporting service 112. One or more of a submitter interface 102, approver interface 106, auditor interface 108, and administrator interface 110 may be the same interface. A user may have multiple roles corresponding to submitter, approver, auditor, and/or administrator. For example, an employee who audits expense reports may also submit their own expense reports.

In some embodiments, a user interface (e.g., submitter interface 102, approver interface 106, auditor interface 108, and/or administrator interface 110) renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In some embodiments, different components of a user interface (e.g., submitter interface 102, approver interface 106, auditor interface 108, and/or administrator interface 110) are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, a user interface may be specified in one or more other languages, such as Java, C, or C++.

In some embodiments, an expense reporting service 112 includes an expense report generation engine 114. An expense report generation engine 114 refers to hardware and/or software configured to perform operations described herein (including such operations as may be incorporated by reference) for generating expense reports.

In some embodiments, an expense reporting service 112 includes an expense recommendation engine 116. An expense recommendation engine 116 refers to hardware and/or software configured to perform operations described herein (including such operations as may be incorporated by reference) for recommending expenses.

In some embodiments, an expense reporting service 112 includes an expense report auditing engine 118. An expense report auditing engine 118 refers to hardware and/or software configured to perform operations described herein (including such operations as may be incorporated by reference) for auditing expense descriptions and/or expense reports.

In some embodiments, an expense reporting service 112 includes a receipt processing engine 120. A receipt processing engine 120 refers to hardware and/or software configured to perform operations described herein (including such operations as may be incorporated by reference) for processing expense receipts.

In some embodiments, an expense reporting service 112 includes a user support engine 122. A user support engine 122 refers to hardware and/or software configured to perform operations described herein (including such operations as may be incorporated by reference) for processing and responding to user queries submitted to the expense reporting service 112.

In some embodiments, one or more components of the expense reporting service use a machine learning engine 124. Machine learning includes various techniques in the field of artificial intelligence that deal with computer-implemented, user-independent processes for solving problems that have variable inputs.

In embodiment, the machine learning engine 124 trains a machine learning model 126 to perform one or more operations. Training a machine learning model 126 uses training data to generate a function that, given one or more inputs to the machine learning model 126, computes a corresponding output. The output may correspond to a prediction based on prior machine learning. In some embodiments, the output includes a label, classification, and/or categorization assigned to the provided input(s). The machine learning model 126 corresponds to a learned model for performing the desired operation(s) (e.g., labeling, classifying, and/or categorizing inputs). An expense reporting service 112 may use multiple machine learning engines 124 and/or multiple machine learning models 126 for different purposes.

In some embodiments, the machine learning engine 124 may use supervised learning, semi-supervised learning, unsupervised learning, reinforcement learning, and/or another training method or combination thereof. In supervised learning, labeled training data includes input/output pairs in which each input is labeled with a desired output (e.g., a label, classification, and/or categorization), also referred to as a supervisory signal. In semi-supervised learning, some inputs are associated with supervisory signals and other inputs are not associated with supervisory signals. In unsupervised learning, the training data does not include supervisory signals. Reinforcement learning uses a feedback system in which the machine learning engine 124 receives positive and/or negative reinforcement in the process of attempting to solve a particular problem (e.g., to optimize performance in a particular scenario, according to one or more predefined performance criteria). In some embodiments, the machine learning engine 124 initially uses supervised learning to train the machine learning model 126 and then uses unsupervised learning to update the machine learning model 126 on an ongoing basis.

In some embodiments, a machine learning engine 124 may use many different techniques to label, classify, and/or categorize inputs. A machine learning engine 124 may transform inputs into feature vectors that describe one or more properties (“features”) of the inputs. The machine learning engine 124 may label, classify, and/or categorize the inputs based on the feature vectors. Alternatively or additionally, a machine learning engine 124 may use clustering (also referred to as cluster analysis) to identify commonalities in the inputs. The machine learning engine 124 may group (i.e., cluster) the inputs based on those commonalities. The machine learning engine 124 may use hierarchical clustering, k-means clustering, and/or another clustering method or combination thereof. In some embodiments, a machine learning engine 124 includes an artificial neural network. An artificial neural network includes multiple nodes (also referred to as artificial neurons) and edges between nodes. Edges may be associated with corresponding weights that represent the strengths of connections between nodes, which the machine learning engine 124 adjusts as machine learning proceeds. Alternatively or additionally, a machine learning engine 124 may include a support vector machine. A support vector machine represents inputs as vectors. The machine learning engine 124 may label, classify, and/or categorizes inputs based on the vectors. Alternatively or additionally, the machine learning engine 124 may use a naïve Bayes classifier to label, classify, and/or categorize inputs. Alternatively or additionally, given a particular input, a machine learning model may apply a decision tree to predict an output for the given input. Alternatively or additionally, a machine learning engine 124 may apply fuzzy logic in situations where labeling, classifying, and/or categorizing an input among a fixed set of mutually exclusive options is impossible or impractical. The aforementioned machine learning model 126 and techniques are discussed for exemplary purposes only and should not be construed as limiting some embodiments.

In some embodiments, as a machine learning engine 124 applies different inputs to a machine learning model 126, the corresponding outputs are not always accurate. As an example, the machine learning engine 124 may use supervised learning to train a machine learning model 126. After training the machine learning model 126, if a subsequent input is identical to an input that was included in labeled training data and the output is identical to the supervisory signal in the training data, then output is certain to be accurate. If an input is different from inputs that were included in labeled training data, then the machine learning engine 124 may generate a corresponding output that is inaccurate or of uncertain accuracy. In addition to producing a particular output for a given input, the machine learning engine 124 may be configured to produce an indicator representing a confidence (or lack thereof) in the accuracy of the output. A confidence indicator may include a numeric score, a Boolean value, and/or any other kind of indicator that corresponds to a confidence (or lack thereof) in the accuracy of the output.

In some embodiments, a data repository 128 is any type of storage unit and/or device (e.g., a file system, database, collection of tables, or any other storage mechanism) for storing data. Further, a data repository 128 may include multiple different storage units and/or devices. The multiple different storage units and/or devices may or may not be of the same type or located at the same physical site. Further, a data repository 128 may be implemented or may execute on the same computing system as one or more other components of the system 100. Alternatively or additionally, a data repository 128 may be implemented or executed on a computing system separate from one or more other components of the system 100. A data repository 128 may be communicatively coupled to one or more other components of the system 100 via a direct connection or via a network.

In some embodiments, a data repository 128 is configured to store historical expense data 130. Historical expense data 130 may include any kind of data that the expense reporting service 112 has previously received and/or generated in association with expenses. Specifically, the historical expense data 130 may include expense reports, expense descriptions, metadata associated with expenses (e.g., geotags, dates and times, explanatory notes, and/or another kind of metadata or combination thereof), and/or any other kind of data or combination thereof associated with expenses. Historical expense data 130 may include data that is associated with one or more employees' target activity, which may also be associated (directly or indirectly) with one or more expenses. For example, historical expense data 130 may include one or more itineraries, location check-ins, phone records, emails, social media messages, calendar appointments, and/or any other kind of data or combination thereof associated with business-related activity.

In some embodiments, a data repository 128 is configured to store one or more expense preferences 131. An expense preference 131 includes one or move values that indicates one or more employees' preferences related to expenses that the employee(s) may incur during target activity. For example, an expense preference 131 may indicate that an employee prefers ride sharing over public transportation. As another example, an expense preference 131 may indicate that an employee has a dietary restriction (e.g., vegetarian, vegan, kosher, etc.). As another example, an expense preference 131 may indicate that an employee likes or dislikes a particular restaurant, hotel, or other establishment. An embodiment, an expense reporting service 112 uses a machine learning engine 124 to infer one or more employee preferences 131 from historical expense data 130. One or more triggers described herein may be based, at least in part, on one or more expense preferences 131.

In some embodiments, a data repository 128 is configured to store one or more expense policies 132. An expense policy 132 may be a set of one or more codified rules corresponding to criteria for reimbursable expenses. For example, example, an expense policy 132 may define one or more expense categories that are used to categorize reimbursable expenses (e.g., meals, transportation, incidentals, equipment, etc.). As another example, an expense policy 132 may define an expense limit that is applicable to one or more employees and/or one or more expense categories for a particular unit of time (e.g., day, week, month, year, etc.). As another example, an expense policy 132 may identify one or more kinds of expenses and/or establishments (e.g., particular stores or restaurants) for which expenses are not reimbursable. Many different kinds of expense policy 132 may be defined. An expense policy 132 may apply the level of an entire organization, a business unit, a team, an individual, or any other set of one or more employees or combination thereof.

In some embodiments, a data repository 128 is configured to store one or more expense guidelines 134. An expense guideline 134 may be a set of one or more codified rules corresponding to best practices for expenses and/or responsible spending guidelines. An expense guideline 134 may be more restrictive than an expense policy 132. For example, a particular expense that satisfies an expense policy 132 may fail to satisfy an expense guideline 134 because, even though the expense is within an allowable limit under the expense policy 132, the expense is inconsistent with responsible spending guidelines. An expense guideline 134 may apply the level of an entire organization, a business unit, a team, an individual, or any other set of one or more employees or combination thereof.

In some embodiments, a data repository 128 is configured to store one or more expense patterns 136. An expense pattern 136 identifies a typical and/or expected arrangement of expenses associated with target activity. An expense pattern 136 may be associated with target activity having one or more shared characteristics (e.g., a certain kind of business trip, business-related activity for a particular category of employees, or any other kind of shared characteristic or combination thereof). An expense pattern 136 may identify expenses that are typical for target activity having the shared characteristic(s). In one example, an expense pattern 136 identifies that international business travel typically includes: (1) airfare to and from the destination; (2) a rental car, public transportation, and/or ride sharing at the destination; (3) a hotel for the duration of the trip; (4) an international data roaming plan; and (5) three meals per day at the destination. An expense reporting system 112 may use an expense pattern 136 to identify reimbursable expenses for which an employee may have neglected to submit an expense report (e.g., based on a gap or difference between reported expenses and the expense pattern 136), and/or recommended reimbursable expenses that an employee might otherwise overlook. In some embodiments, an expense reporting service 112 uses a machine learning engine 124 to infer one or more expense patterns 136, based at least in part on historical expense data 130.

In some embodiments, a data repository 128 is configured to store one or more expense triggers 138. An expense trigger 138 is a codified set of rules and/or a set of automatically learned patterns that capture one or more conditions for identifying expenses associated with one or more employees' business-related activity. An expense identified by an expense trigger may be an expense for which an employee has not yet prepared and/or submitted an expense report.

In some embodiments, an expense trigger 138 is based, at least in part, on data corresponding to business-related activity of an employee and/or historical expense data 130. As one example, an expense trigger 138 identifies that a transportation expense may be available when an employee travels from one location to another (e.g., from the employee's home or office to the airport). As another example, an expense trigger 138 identifies that a hotel expense may be available when geolocation data (e.g., from a global positioning system (GPS), a social media check-in, and/or any other kind of data source that supplies geolocation data) indicates that the user has arrived at a hotel or is leaving a hotel. As another example, an expense trigger 138 identifies that a meal expense may be available when geolocation data (e.g., from a global positioning system (GPS), a social media check-in, and/or any other kind of data source that supplies geolocation data) indicates that the user has visited a restaurant.

In some embodiments, when an expense trigger 138 identifies an expense for travel to a location, where return travel is also expected, the expense trigger 138 identifies an expense for the return travel. For example, if an employee prepares an expense description for a taxi to an airport, an expense trigger 138 may identify (e.g., based on an expense pattern 136 for international business travel), a corresponding expense for return travel from the airport.

In some embodiments, an expense trigger 138 is based, at least in part, on one or more expense descriptions prepared by one or more other employees who are traveling with the employee in question. In one example, three employees are participating in the same business trip and two of the employees prepare expense descriptions for a business meal at a particular restaurant. In this example, an expense trigger 138 identify that a corresponding expense at the same restaurant may also apply to the third employee.

In some embodiments, an expense trigger 138 is based, at least in part, on one or more credit card statements for one or more employees. The expense trigger 138 may determine that a particular credit card charge is associated (e.g., corresponds in time and/or geographic location) with an employee's business-related activity. Based on the association between the credit card charge and the employee's business-related activity, the expense trigger 138 may identify the credit card charge as a potentially reimbursable expense.

In some embodiments, an expense trigger 138 is based, at least in part, on a typical and/or expected pairing between two or more different kinds of expenses. In one example, an employee purchases gas at a gas station. However, the employee has not entered an expense description corresponding to a car rental. Based on a typical and expected pairing between gasoline and car rental, an expense trigger 138 may identify a car rental as an available expense for the employee.

In some embodiments, an expense trigger 138 identifies similar expenses over time and identifies an opportunity to enter a recurring expense. As one example, an employee who travels frequently for business submits expense reports each month that include expense descriptions corresponding to an international data roaming plan. An expense trigger 138 may identify the international data roaming plan as a recurring expense. Based on identifying the international data roaming plan as a recurring expense, the expense reporting service 112 may present a message to the employee offering to make the charge a recurring expense, so that the employee does not need to enter the expense description each month.

Many different kinds of expense triggers 138 may be defined. In some embodiments, an expense reporting service 112 uses a machine learning engine 124 to determine an expense trigger 138 as part of a machine learning model 126. Machine learning engine 124 may automatically infer expense triggers even though the exact pattern may not have been seen before. Further, machine learning engine 124 may learn different patterns of behavior that qualify as an expense trigger 138 depending on context. For example, expense triggers may differ depending on employee attributes, such as employee title, clearance level, job responsibilities. Additionally or alternatively, expense triggers may vary between different groups of employees, such as between different companies or organizational departments within the same company. Additionally or alternatively, expense triggers may vary for different temporal patterns, and/or geographic patterns of incurred expenses.

In some embodiments, a data repository 128 is configured to store one or more expense recommendation triggers 139. An expense recommendation trigger 139 is a codified set of rules and/or a set of automatically learned patterns that capture one or more conditions for identifying recommended expenses that are known or expected to be reimbursable. A recommended expense may be an expense that the employee has not yet incurred. In some embodiments, an expense reporting service 112 uses a machine learning engine 124 to determine an expense recommendation trigger 139 as part of a machine learning model 126.

In some embodiments, an expense recommendation trigger 139 is based, at least in part, on data corresponding to business-related activity of an employee and/or historical expense data 130. For example, an expense recommendation trigger 139 may recommend less expensive spending options to an employee who has a tendency to spend above expense limits and/or above expense guidelines. As another example, an expense recommendation trigger 139 may recommend expenses that are popular among similarly situated employees, such as a particular restaurant that other employees have frequented and for which expenses tended to be reimbursed. As another example, an expense recommendation trigger 139 may recommend against frequenting a particular establishment for which expenses tended to be declined.

In some embodiments, an expense recommendation trigger 139 is based, at least in part, on one or more expense preferences 131. For example, an expense recommendation trigger 139 may identify a recommended restaurant for an employee who is vegan or who is meeting with a client who is vegan. As another example, an expense recommendation trigger 139 may identify a recommended restaurant or mode of transportation for an employee who prefers healthy options.

In some embodiments, expense recommendation trigger 139 is based, at least in part, on an expense policy 132 and/or an expense guideline 134. For example, an expense recommendation trigger 139 may identify recommended expenses that increase responsible spending behavior, for example by reducing spending, taking advantage of deals, earning rewards, etc.

In some embodiments, an expense recommendation trigger 139 is based, at least in part, on a determination that one expense is less expensive and/or more likely to be reimbursable than another expense. Recommending less expensive options may reduce expenses for an organization and decrease the incidence of expenses that need to be audited and/or are declined for reimbursement.

In some embodiments, an expense recommendation trigger 139 is based, at least in part, on an employee's spending score. An employee's spending score may be based, at least in part, on historical expense data 130 associated with the employee. For example, the employee spending score may be based on one or more of: whether the employee tends to be below spending limits; an average time that the employee takes to prepare expense descriptions for expenses that have already been incurred; an audit history of the employee (e.g., a history of allowed and/or rejected expense descriptions, which may be expressed as a ratio or some other metric); a comparison of the employee's past spending with a expense policy (e.g., a spending limit); and/or any other kind of data or combination thereof associated with the employee's spending. In some embodiments, employees with ‘better’ spending scores are at lower risk of audits than employees with ‘worse’ spending scores. An expense recommendation trigger 139 may identify less expensive options for employees with ‘worse’ spending scores than for employees with ‘better’ spending scores.

In some embodiments, an expense recommendation trigger 139 is based on one or more attributes of past, present, and/or planned business-related activity of an employee (e.g., a business trip or another kind of business-related activity). For example, trips of at least a threshold duration may qualify for certain reimbursable expenses (e.g., dry cleaning). As another example, flights of at least a threshold duration may qualify for a reimbursable seat upgrade. As another example, travel to international destinations may qualify for reimbursable international data roaming charges.

In some embodiments, an expense recommendation trigger 139 is based, at least in part, on an expense limit for a trip compared with an amount of expenses already incurred for the trip. For example, an expense recommendation trigger 139 may identify recommended expenses that are less expensive than other options, for an employee who is running out of expense budget on a trip. The expense recommendation trigger 139 may compare a remaining budget with a remaining time on the trip and recommend expenses that allocate the remaining budget across the remaining time.

In some embodiments, an expense recommendation trigger 139 is based, at least in part, on information about employees who are participating in the same business-related activities. For example, an expense recommendation trigger 139 may identify ride-sharing and/or other expense sharing opportunities for employees traveling to the same destination. The system 100 may present the recommended expense to one or more of those employees, to help encourage savings available by sharing expenses.

In some embodiments, a data repository 128 is configured to store one or more approval triggers 140. An approval trigger 140 is a codified set of rules and/or a set of one or more automatically learned patterns that capture one or more conditions for requiring approval of an expense description and/or expense report before submitting the expense description and/or expense report for reimbursement. An approval trigger 140 may be based, at least in part, on data corresponding to business-related activity of an employee and/or historical expense data 130. For example, an approval trigger 140 may indicate that all expense description requires approval if the expense exceeds or is within a certain amount of an expense limit. As another example, an approval trigger 140 may indicate that all expense descriptions in a particular category, and/or all expense descriptions prepared for a particular employee, require approval. As another example, expense descriptions that violate an expense policy 132 and/or an expense guideline 134 may require approval. As another example, employees themselves may be required to approve expense descriptions that are generated by the expense reporting service 112 in a user-independent mode (e.g., based on an expense trigger 138). Many different kinds of approval triggers 140 may be defined. In some embodiments, an expense reporting service 112 uses a machine learning engine 124 to determine an approval trigger 140 as part of a machine learning model 126.

In some embodiments, a data repository 128 is configured to store one or more audit triggers 142. An audit trigger 142 is a codified set of rules and/or a set of automatically learned patterns that capture one or more conditions for requiring auditing of an expense report, and/or for determining that an expense report or description is at risk of being audited. An audit trigger 142 may be based, at least in part, on data corresponding to business-related activity of an employee and/or historical expense data 130. In some embodiments, an audit trigger 142 is based, at least in part, on an audit risk score associated with a particular expense description. An audit trigger 142 may be satisfied when an audit risk score satisfies one or more threshold criteria (e.g., the audit risk score may be above or below a threshold number, or any other kind of threshold criteria or combination thereof). In some embodiments, an expense reporting service 112 uses a machine learning engine 124 to determine an audit trigger 142 as part of a machine learning model 126.

In some embodiments, a data repository 128 is configured to store one or more user credentials 144. An expense reporting service 112 may use a user credential 144 to access an external data source 146 and obtain data from the external data source 146. A user credential 144 may include a username, user identifier (ID), password, private key, public key, and/or any other kind of credential or combination thereof. In some embodiments, an employee supplies a user credential 144 to an expense reporting system 122 via a graphical user interface. For example, the expense reporting service 112 may use three-party authentication to obtain a user credential 144 from an employee.

In some embodiments, user data that is input into machine learning engine 124 is anonymized. Personal identifying information (PII) and other sensitive information may be replaced with an anonymous identifier, such as a cryptographic hash of the user data. Machine learning engine 124 may use the anonymized data to learn patterns and make predictions for different employees, within the same or different organizations, having similar attributes without compromising or revealing sensitive employee data.

Information describing one or more components that are illustrated here within a data repository 128 may be implemented across any of components within the system 100. However, this information is illustrated within the data repository 128 for purposes of clarity and explanation.

In some embodiments, an expense reporting service 112 is configured to receive data from one or more external data sources 146. An external data source 146 refers to hardware and/or software operating independent of the expense reporting service 112, i.e., under control of a different entity (e.g., a different company or other kind of organization) than an entity that controls the expense reporting service 112. An external data source 146 may supply data associated with an employee's business-related activity, such as travel, dining, meals, itineraries, appointments, emails, phone data, social media messages, credit card statements (e.g., for a business-provided credit card), and/or any other kind of target activity or combination thereof. The data may include information associated with an employee's expenses, which may or may not be reimbursable.

Some examples of an external data source 146 supplying data to an expense reporting service 112 include, but are not limited to: an airline or travel agency supplying data associated with an itinerary and/or ticket purchase; a food ordering application supplying data associated with a food order; a ride sharing service (e.g., Uber™, Lyft™, or another ride sharing service) supplying data associated with an instance of ride sharing; and a social media application (e.g., Facebook™, Foursquare™, or another social media application) supplying data corresponding to a check-in at a location (e.g., a restaurant, hotel, entertainment venue, or other location). Many different kinds of external data sources 146 may supply many different kinds of data.

In some embodiments, an expense reporting service 112 is configured to retrieve data from an external data source 146 by ‘pulling’ the data via an application programming interface (API) of the external data source 146, using user credentials 144 that a user has provided for that particular external data source 146. Alternatively or additionally, an external data source 146 may be configured to ‘push’ data to the expense reporting service 112 via an API of the expense reporting service, using an access key, password, and/or other kind of credential that a user has supplied to the external data source 146. An expense reporting service 112 may be configured to receive data from an external data source 146 in many different ways.

In some embodiments, a reimbursement service 148 refers to hardware and/or software configured to perform operations for reimbursing approved expenses. For example, the reimbursement service 148 may be part of an accounting service that applies reimbursements for approved expenses to employee's paychecks and/or separate reimbursement checks, which may be mailed to employees and/or direct-deposited into employee's bank accounts. Many different techniques for reimbursing approved expenses exist.

In some embodiments, one or more components of the system 100 implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

3. PRESENTING EXPENSES IN AN EXPENSE REPORT REVIEWING INTERFACE

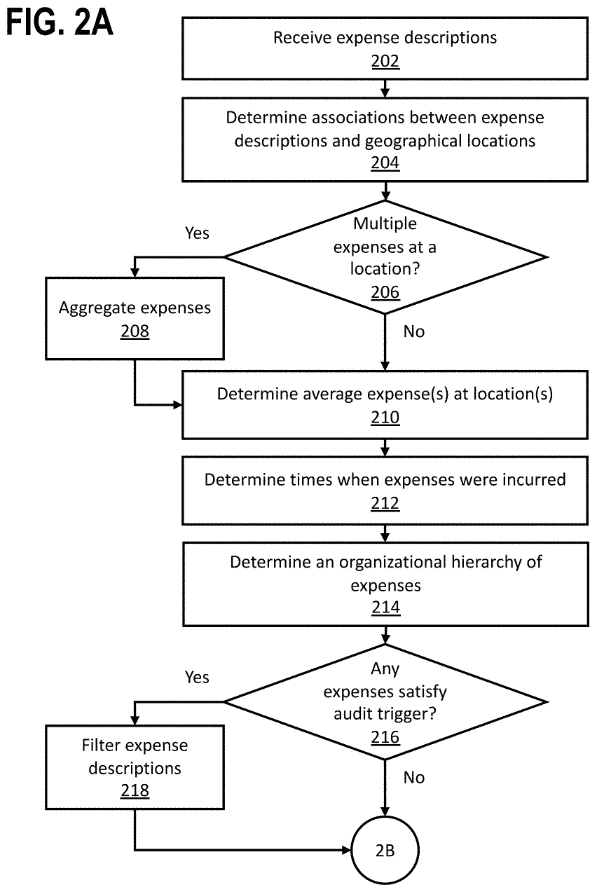

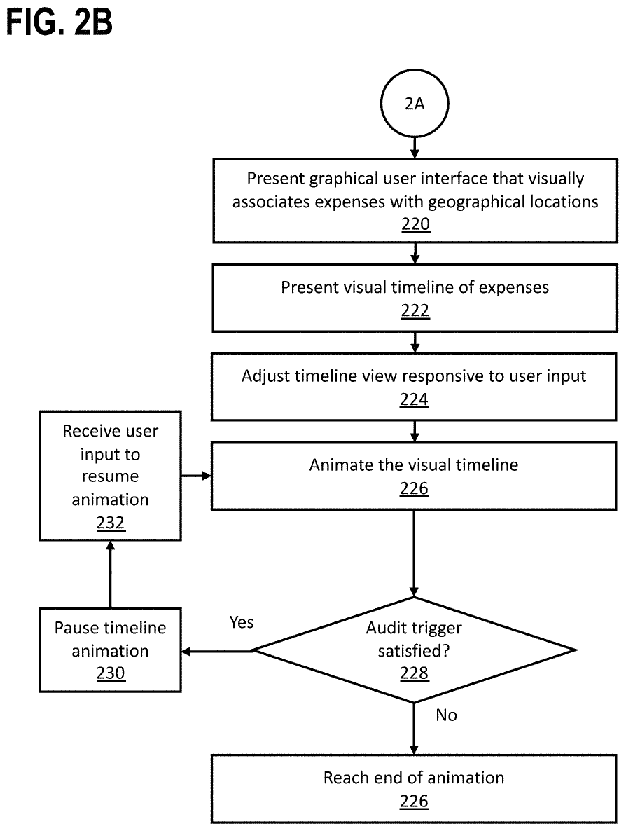

FIGS. 2A-2B illustrate an example set of operations for presenting expenses in an expense report reviewing interface in accordance with some embodiments. One or more operations illustrated in FIGS. 2A-2B may be modified, rearranged, or omitted all together. Accordingly, the particular sequence of operations illustrated in FIGS. 2A-2B should not be construed as limiting the scope of some embodiments.

In some embodiments, a system (e.g., one or more components of the system 100 illustrated in FIG. 1) receives expense descriptions (Operation 202). One or more of the expense descriptions may be associated with one or more expenses already incurred by the employee. Alternatively or additionally, one or more of the expense descriptions may be associated with one or more anticipated or planned expenses not yet incurred by the employee, such that the employee is able to use the system to determine an audit risk associated with the expense(s) before actually incurring the expense(s). A user may supply user input corresponding to an expense description. Alternatively or additionally, the system may generate an expense description in a user-independent mode (i.e., without requiring or requesting user input corresponding to instructions to generate the expense description(s)), for example based on an expense trigger.

In some embodiments, the system determines associations between the expense descriptions and geographical locations (Operation 204). The system may determine associations between expense descriptions and geographical locations based on metadata associated with expense descriptions. For example, an expense description may be associated with a geotag corresponding to a location where the expense was incurred. The geotag may be in the form of geographical coordinates or any other kind of geotag or combination thereof. The system may process data associated with the expense description to obtain the geotag. In one example, an expense description includes a scanned receipt. The system performs optical character recognition (OCR) on the receipt to obtain the name of an establishment that issued the receipt. The system performs a lookup of the establishment's location to determine a geotag for the expense description. Alternatively or additionally, the system may determine associations between expense descriptions and geographical locations by correlating expense descriptions with location data from one or more other data sources. In one example, an expense description includes a date and time when the expense was incurred. The system determines that at approximately the same time, the employee checked into a location on a social media platform. The system may associate the location of the check-in with the expense description. The system may determine associations between expense descriptions and geographical locations in many different ways.

In some embodiments, the system determines whether multiple expense descriptions are associated with the same geographical location (Operation 206). Multiple expense descriptions associated with the same geographical location may correspond to multiple expenses incurred by the same employee at the same location. Alternatively or additionally, multiple expense descriptions associated with the same geographical location may correspond to multiple expenses incurred by the multiple employees at the same location. If multiple expenses are associated with the same geographical location, the system may aggregate the expenses (Operation 208). Aggregating the expenses provides a total amount of expenses incurred (i.e., by one employee and/or by multiple employees) at that location.

In some embodiments, the system determines average expenses incurred at one or more of the geographical locations (Operation 210). Specifically, the system may divide a total amount of expenses incurred by employees at that location by the total number of expenses contributing to the total amount. Alternatively or additionally, the system may calculate a mean amount of expenses incurred by employees at that location.

In some embodiments, the system determines times (including dates) when each of the expenses were incurred (Operation 212). The system may determine times when expenses were incurred based on metadata associated with expense descriptions. For example, an expense description may be associated with a recorded time when the expense was incurred. The recorded time may be in ISO 8601 format or any other kind of date-time format or combination thereof. The system may process data associated with the expense description to obtain the time when the expense was occurred. In one example, an expense description includes a scanned receipt. The system performs optical character recognition (OCR) on the receipt to obtain the time when the receipt was issued. Alternatively or additionally, the system may determine times when expenses were incurred by correlating expense descriptions with time data from one or more other data sources. In one example, an expense description includes a location where the expense was incurred. The system determines that the employee checked into that location on a social media platform at a particular time. The system may associate the time of the check-in with the expense description. The system may determine times when expenses were incurred in many different ways.

In some embodiments, the system determines an organizational hierarchy of the expense descriptions (Operation 214). Specifically, expenses may be associated with multiple employees whose position within an organization correspond to different roles in a hierarchical organizational structure (e.g., lower-level employees in different business units, managers at different levels in different business units, vice presidents, president, C-level executives, etc.). The system may generate a data structure (e.g., an extensible markup language (XML) file) that maps the expense descriptions, associated with different employees, to the employees' respective roles in the hierarchical organizational structure.

In some embodiments, the system determines whether any of the expense descriptions satisfy an audit trigger (Operation 216). If any of the expense descriptions satisfy an audit trigger, the system may filter the expense descriptions (Operation 218). In some embodiments, filtering the expense descriptions creates two sets of expense descriptions: those that satisfy the audit trigger and those that do not satisfy the audit trigger. If all of the expense descriptions satisfy the audit trigger, then the set of expense descriptions that do not satisfy the audit trigger may be empty or non-existent.

In some embodiments, the system presents a graphical user interface (GUI) that visually associates expenses with geographical locations where the expenses were incurred (Operation 220). Specifically, the GUI may include a geographical map corresponding to some or all of the locations where the expenses were incurred. In addition, the GUI may include an overlay to the geographical map that represents the expenses incurred at the shown location(s). The overlay may include individual and/or aggregate expense amounts.

Alternatively or additionally, the expenses represented in the overlay may be logically grouped or filtered by one or more criteria, such as: one or more roles in an organizational structure (which expenses may be visually arranged according to the corresponding hierarchy in the GUI); expenses that satisfy an audit filter; expenses that do not satisfy an audit filter; expenses incurred in a particular timeframe; expenses associated with at particular event (e.g., a particular business trip, promotional event, etc.); expenses incurred by one or more particular employees and/or business unit; and/or any other kind of filter or combination thereof. In some embodiments, the system applies different visual indicators in the overlay to expenses that satisfy different criteria. For example, the system may apply one kind of visual indicator (e.g., a red icon or flag, or another kind of visual indicator) to expenses that require auditing, and another kind of visual indicator (e.g., a green icon or flag, or another kind of visual indicator) to expenses that do not require auditing. Alternatively or additionally, the system may present, in the GUI, a comparison of a particular expense with an average expense amount incurred at that location.

In some embodiments, the system does not permit submission of an expense report for reimbursement until all expense descriptions that satisfy an audit trigger have been approved or rejected. For expense descriptions that do not satisfy an expense trigger, the system may include one or more user controls that permit bulk approval for reimbursement. For example, when viewing a filtered subset of expense descriptions, a user may supply input to ‘approve all’ of those expense descriptions.

In some embodiments, the system presents a GUI that includes a visual timeline of expenses (Operation 222). A GUI that includes a visual timeline of expenses may be a same GUI that visually associates expenses with geographical locations where the expenses were incurred, or may be a different GUI. The visual timeline of expenses may also be referred to as a “timeline view” of the expenses. The timeline view may include information about expenses associated with different times in the timeline. In some embodiments, when a particular time on the timeline is selected, only information about expenses associated with that time are shown. The timeline view may include individual and/or aggregate expense amounts. Alternatively or additionally, the expenses represented in the timeline view may be filtered by one or more criteria, such as: one or more roles in an organizational structure; expenses that satisfy an audit filter; expenses that do not satisfy an audit filter; expenses incurred at one or more particular locations; expenses associated with at particular event (e.g., a particular business trip, promotional event, etc.); expenses incurred by one or more particular employees and/or business unit; and/or any other kind of filter or combination thereof.

In some embodiments, the system adjusts the timeline view responsive to user input (Operation 224). For example, a user may supply input to select one or more particular times in the timeline view. Responsive to the timeline view, the system may present information associated with expenses incurred at the selected time(s). The timeline view may allow a user to ‘scrub’ across the timeline to view information associated with expenses incurred at different times. Alternatively or additionally, the timeline view may visually associate expenses with geographical locations where the expenses were incurred. A user may supply input to select one or more particular locations on the geographical map. Responsive to the user input, the system may show which time(s) in the timeline are associated with expenses incurred at the selected location(s). A user may supply input that causes the system to adjust the timeline view in many different ways.

In some embodiments, the system animates the visual timeline (Operation 226). Specifically, the system may display an animation in which information about expenses is displayed in a particular temporal order (e.g., from oldest to most recent). As the animation proceeds, the system may highlight, on a geographical map, one or more routes traveled by one or more employees who incurred the expenses.

In some embodiments, while animating the visual timeline, the system determines whether an expense description that is currently represented in the visual timeline (i.e., for which data is currently visible, at the currently presented point in time of the animation) satisfies an audit trigger (Operation 228). As discussed above, an audit trigger is a codified set of rules that defines one or more conditions for requiring auditing of an expense report, and/or for determining that an expense report or description is at risk of being audited. If the system determines that an expense description that is currently represented in the visual timeline satisfies an audit trigger, the system may pause the animation (Operation 230). Pausing the animation may help draw the attention of a user (e.g., a user in an auditor role, using the GUI to audit expense descriptions) to the expense description(s) that satisfy the audit trigger. The system may also prompt a user to approve or reject the expense description that caused the system to pause the animation. Alternatively or additionally, the system may pause the animation if the system identifies a gap in the visual timeline (e.g., the employee did not submit any expense description for lunch on a particular day). The system may identify the gap based on an expense pattern. The system may subsequently receive user input to resume the animation (Operation 232). The user input may correspond to approving or rejecting an expense description. Alternatively, the user input may simply instruct the system to resume the animation. In some embodiments, responsive to the user input, the system resumes animating the visual timeline (Operation 226).

In some embodiments, if the system does not determine that an expense description that is currently represented in the visual timeline satisfies an audit trigger, then the animation continues until the system reaches the end of the animation (Operation 226). At any point in the animation, a user may supply user input to pause, rewind, fast-forward, or otherwise move to another point in time in the animation.

4. ADJUSTING EXPENSE LIMITS

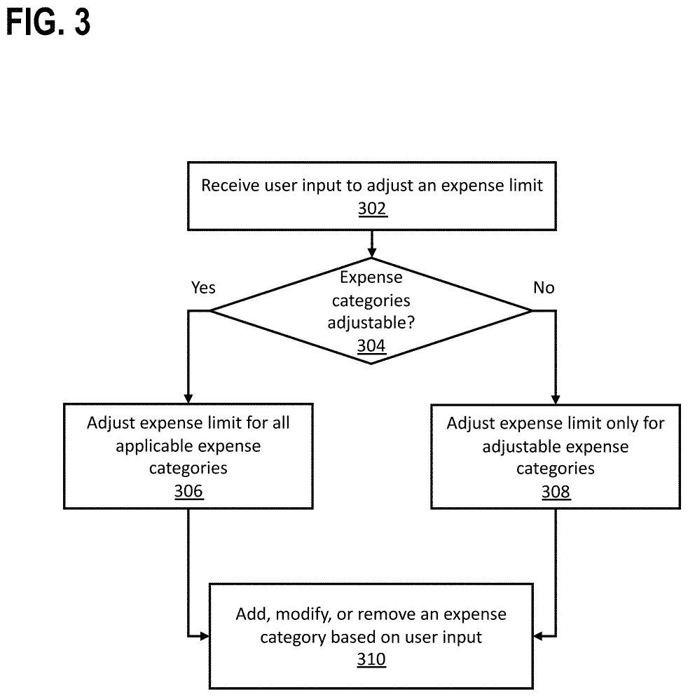

FIG. 3 illustrates an example set of operations for adjusting expense limits in accordance with some embodiments. One or more operations illustrated in FIG. 3 may be modified, rearranged, or omitted all together. Accordingly, the particular sequence of operations illustrated in FIG. 3 should not be construed as limiting the scope of some embodiments.

In some embodiments, a system (e.g., one or more components of the system 100 illustrated in FIG. 1) receives user input to adjust an expense limit (Operation 302). In some embodiments, the expense limit applies to multiple expense categories (e.g., categories such as transportation, meals, lodging, incidentals, and/or any other expense category or combination thereof). In one example, an administrator supplies input that instructs the system to decrease an expense limit for international travel (which typically includes multiple categories of expenses) by 5 percent. In another example, an administrator supplies input that instructs the system to increase an expense limit for promotional events (which typically includes multiple categories of expenses) by 15 percent. Alternatively or additionally, the expense limit may apply to multiple employees, such as all employees in the organization and/or all employees in one or more particular business units. The user input may correspond to an instruction to change the expense limit as a matter of expense policy and/or expense guideline that does not apply only to one or more individual employees.

In some embodiments, expense limits for one or more expense categories are not adjustable in the manner instructed by the user. For example, it may not be possible to decrease an expense limit for transportation by 5 percent, if doing so would decrease the expense limit below available airfares. In some embodiments, the system determines whether all expense categories to which the user input applies are adjustable in the manner instructed (Operation 304).

If all the expense categories to which the user input applies are adjustable in the manner instructed, then the system adjusts the expense limit for all the applicable expense categories (Operation 306).

If one or more expense categories to which the user input applies are not adjustable in the manner instructed, then the system adjusts the expense limit only for the applicable expense categories that are adjustable in the manner instructed (Operation 308).

In some embodiments, a system administrator has permissions to add, modify, or remove expense categories from the system. For example, a system administrator may seek to remove an expense category that is obsolete and/or never allowed. As another example, a system administrator may seek to add an expense category corresponding to a kind of expenses that are increasingly seen in expense reports. As another example, a system administrator may seek to rename an expense category (e.g., from “dial-up expense” to “Internet access”). In some embodiments, the system receives user input to add, modify, or remove an expense category and adds, modifies, or removes the expense category accordingly (Operation 310).

5. ADJUSTING EXPENSE LIMITS USING MACHINE LEARNING

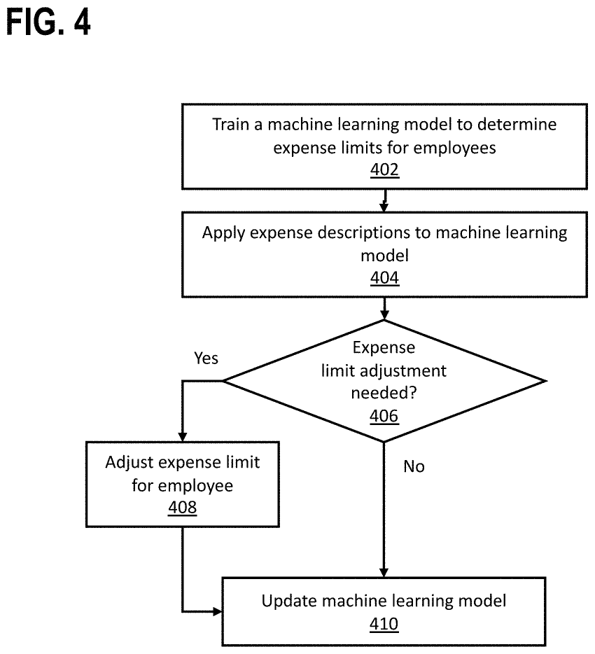

FIG. 4 illustrates an example set of operations for adjusting expense limits using machine learning in accordance with some embodiments. One or more operations illustrated in FIG. 4 may be modified, rearranged, or omitted all together. Accordingly, the particular sequence of operations illustrated in FIG. 4 should not be construed as limiting the scope of some embodiments.

In some embodiments, a system (e.g., one or more components of the system 100 illustrated in FIG. 1) trains a machine learning model to determine expense limits for employees (Operation 402). The machine learning model may use, as input, historical expense data and/or other data associated with employees' activity. The training dataset may identify activities that exceeded and fell within expense limits. For instance, an example in the training dataset may include a set of activities and expenses incurred by an employee over a given timeframe and a label indicating whether or not an expense limit was exceeded and/or adjusted within the timeframe.

In some embodiments, the system generates a set of feature vectors based to train the machine learning model. A feature vector for an example may be n-dimensional, where n represents the number of features in the vector. The number of features that are selected may vary depending on the particular implementation. The features may be curated in a supervised approach or automatically selected from extracted set of attributes during model training and/or tuning. Example features include information about the employee that incurred an expense (e.g., employee job title, clearance level, department), geographic information about where an expense or activity occurred (e.g., continent, country, state, city), temporal information about when an expense or activity occurred (e.g., date and time), categorical information about what type of an expense was incurred or activity performed (e.g., vendor identifier, vendor category, product identifier, product category, activity name, activity patterns), and the expense amount. In some embodiments, a feature within a feature vector is represented numerically by one or more bits. The system may convert categorical attributes to numerical representations using an encoding scheme, such as one hot encoding.

In some embodiments, expense descriptions are mapped to one or more features of a machine learning feature vector. The system may generate feature vectors from historical examples based at least in part on the expense descriptions extracted from the historical examples. The system may train the machine learning model to capture patterns in expense descriptions that are predictive that an expense limit should be adjusted.

In some embodiments, the training process includes adjusting weights applied as a function of the input feature vector(s) and/or other model parameters to minimize an estimation error of the machine learning model. For example, in the context of a neural network, the nodes may be assigned an initial weight. Predictions about whether an expense limit was exceeded/adjusted may be made using the model and compared against observed values in a test dataset. The system may then train a neural network using backpropagation. Backpropagation is a process of updating cell states in the neural network based on gradients determined as a function of the estimation error. With backpropagation, nodes are assigned a fraction of the estimated error based on the contribution to the output and adjusted based on the fraction. Time may also be factored into the backpropagation process in recurrent neural networks. For instance, an example may include expenses e₁, e₂, and e₃ corresponding to times t, t+1, and t+2, respectively. Backpropagation through time may perform adjustments through gradient descent starting at time t+2 and moving backward in time to t+1 and then to t. Further, the backpropagation process may adjust the memory parameters of a cell such that a cell remembers contributions from previous expenses in the sequence of expenses. For example, a cell computing a contribution for e₃ may have a memory of the contribution of e₂, which has a memory of e₁. The memory may serve as a feedback connection such that the output of a cell at one time (e.g., t) is used as an input to the next time in the sequence (e.g., t+1). The gradient descent techniques may account for these feedback connections such that the contribution of one expense or activity to a cell's output may affect the contribution of the next expense or activity in the cell's output. Thus, the contribution of e₁ may affect the contribution of e₂, etc.

Additionally or alternatively, the system may train other types of machine learning models. For example, the system may adjust the boundaries of a hyperplane in a support vector machine or node weights within a decision tree model to minimize estimation error. Once trained, the machine learning model may be used to estimate labels for new examples of expenses.

In some embodiments, the system applies expense descriptions that are associated with a particular employee to the machine learning model (Operation 404). The system may apply the expense descriptions by forming one or more feature vectors and feeding the feature vectors as input to the trained machine learning model. For example, the system may perform a forward pass using the trained neural network, evaluate a decision tree, or determine a location on a hyperplane relative to the boundaries in a trained hyperplane to output an estimated label as a function of the input set of one or more feature vectors.

Based on output of the machine learning model, the system determines whether an expense limit adjustment is needed for that employee (Operation 406). For example, if an employee tends to overspend relative to an existing expense limit, the system may determine that a downward adjustment of that employee's personal expense limit is needed. As another example, if an employee tends to overspend relative to an existing expense limit, but the overspending is typically approved during auditing (e.g., the employee tends to overspend on client dinners that result in lucrative deals), the system may determine that an upward adjustment of that employee's personal expense limit is needed. In this example, adjusting the employee's expense limit upward may decrease the number of the employee's expense descriptions that are flagged for auditing, thereby preserving auditing resources that are better used to review problematic spending. The estimated label output by the machine learning model may predict whether the expense limit for the particular employee should be adjusted. The estimated label may further indicate an amount that the expense limit should be adjusted.

In some embodiments, if the system determines that an expense limit adjustment is needed, the system adjusts the expense limit for the employee (Operation 408). Additionally or alternatively, the system may notify an auditor or other user to review the expense limit for the particular employee.

In some embodiments, the system updates the machine learning model (Operation 410), based on the expense descriptions and/or expense limit adjustment. The system may update the machine learning model using supervised or unsupervised learning. For example, an auditor may review an expense limit adjustment that was automatically made by the system. The auditor may approve the adjustment, modify the adjustment, and/or reject the adjustment. The input from the auditor may be used as feedback to adjust the weights and/or other model parameters of the machine learning model.

6. ILLUSTRATIVE EXAMPLES

A detailed example is described below for purposes of clarity. Components and/or operations described below should be understood as one specific example which may not be applicable to certain embodiments. Accordingly, components and/or operations described below should not be construed as limiting the scope of any of the claims.

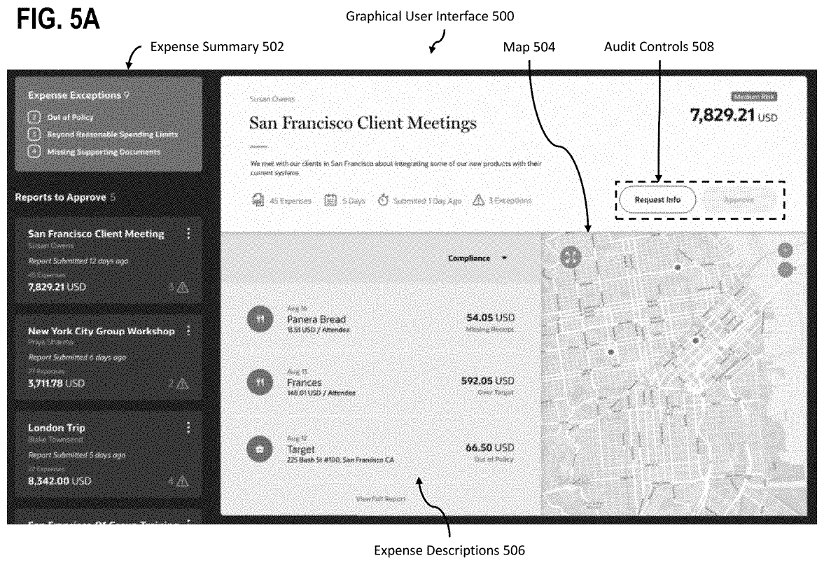

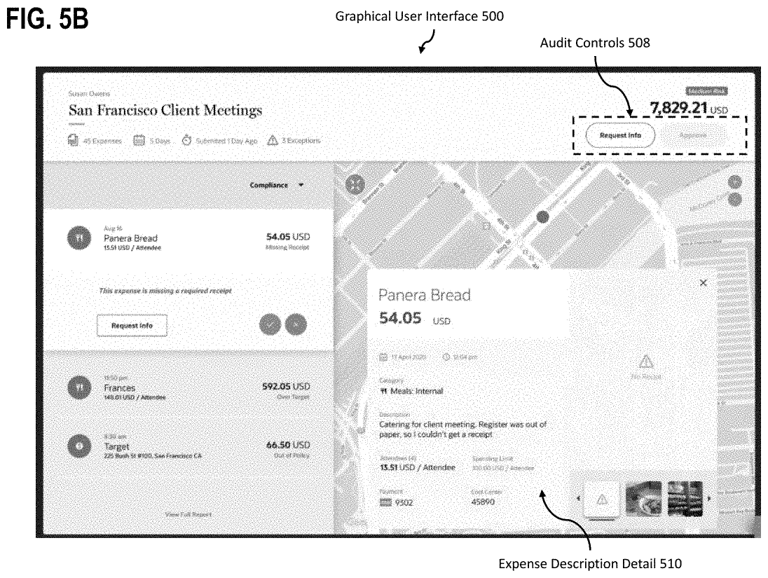

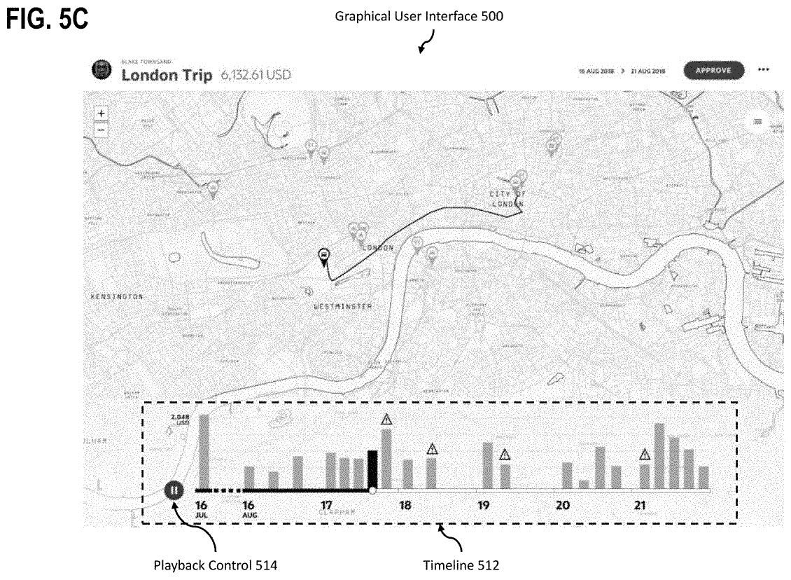

FIGS. 5A-5C illustrate examples in accordance with some embodiments. As illustrated in FIG. 5A, a graphical user interface (GUI) 500 associates expenses with locations where the expenses were incurred. An expense summary 502 presents summary information about the expenses, including how many expense descriptions require auditing and options to select particular business events to view in the GUI 500. A geographical map 504 represents the locations where the expenses were incurred. As seen in FIG. 5A, an overlay places dots on the map 504 at the specific locations where the expenses were incurred. The GUI 500 also includes audit controls 508 that permit a user in an auditor role to approve expense descriptions and/or request additional information from employees regarding questionable expense descriptions. As illustrated in FIG. 5B, the GUI 500 can overlay expense description detail 510 for a particular selected expense. In FIG. 5C, the GUI 500 includes a timeline 512 along with a playback control 514 that allows a user to pause or resume an animation of the timeline view. The map includes an overlay of a route traveled by an employee when incurring the expenses.

7. HARDWARE OVERVIEW

According to one embodiment, the techniques described herein are implemented by one or more special-purpose computing devices (i.e., computing devices specially configured to perform certain functionality). The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

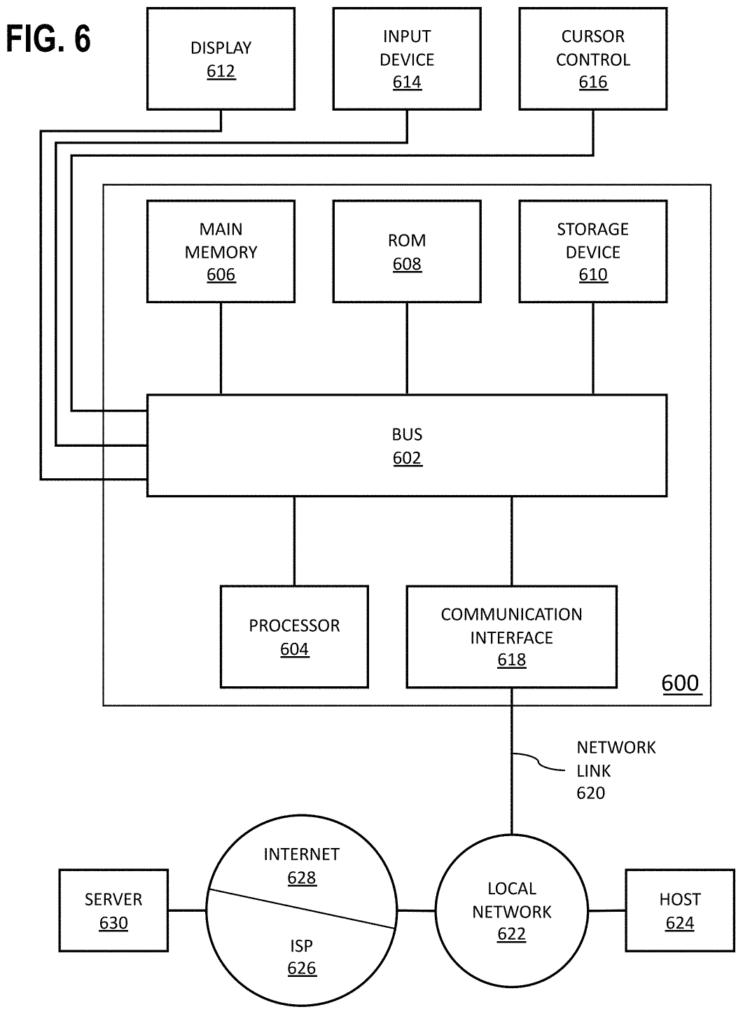

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a liquid crystal display (LCD), plasma display, electronic ink display, cathode ray tube (CRT) monitor, or any other kind of device for displaying information to a computer user. An input device 614, including alphanumeric and other keys, may be coupled to bus 602 for communicating information and command selections to processor 604. Alternatively or in addition, the computer system 600 may receive user input via a cursor control 616, such as a mouse, a trackball, a trackpad, a touchscreen, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane. The display 612 may be configured to receive user input via one or more pressure-sensitive sensors, multi-touch sensors, and/or gesture sensors. Alternatively or in addition, the computer system 600 may receive user input via a microphone, video camera, and/or some other kind of user input device (not shown).

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a programmable read-only memory (PROM), and erasable PROM (EPROM), a FLASH-EPROM, non-volatile random-access memory (NVRAM), any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a network, via a network interface controller (NIC), such as an Ethernet controller or Wi-Fi controller. A NIC local to computer system 600 can receive the data from the network and place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

8. COMPUTER NETWORKS AND CLOUD NETWORKS

In some embodiments, a computer network provides connectivity among a set of nodes running software that utilizes techniques as described herein. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be any physical resource that provides compute power to perform a task, such as one that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In some embodiments, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In some embodiments, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In some embodiments, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any applications, including an operating system, may be deployed on the network resources.

In some embodiments, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In some embodiments, tenants of a multi-tenant computer network are independent of each other. For example, one tenant (through operation, tenant-specific practices, employees, and/or identification to the external world) may be separate from another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In some embodiments, in a multi-tenant computer network, tenant isolation is implemented to ensure that the applications and/or data of different tenants are not shared with each other. Various tenant isolation approaches may be used.

In some embodiments, each tenant is associated with a tenant ID. Each network resource of the multi-tenant computer network is tagged with a tenant ID. A tenant is permitted access to a particular network resource only if the tenant and the particular network resources are associated with a same tenant ID.

In some embodiments, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In some embodiments, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In some embodiments, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

9. MICROSERVICE APPLICATIONS

According to some embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using Hypertext Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may alternatively or additionally provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In some embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

Triggers

The techniques described above may be encapsulated into a microservice, according to some embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

Actions

In some embodiments, a plugged-in microservice application may expose actions to the microservices manager. The exposed actions may receive, as input, data or an identification of a data object or location of data, that causes data to be moved into a data cloud.

In some embodiments, the exposed actions may receive, as input, a request to increase or decrease existing alert thresholds. The input might identify existing in-application alert thresholds and whether to increase or decrease, or delete the threshold. Additionally or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In some embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

10. MISCELLANEOUS; EXTENSIONS

Embodiments are directed to a system with one or more devices that include a hardware processor and that are configured to perform any of the operations described herein and/or recited in any of the claims below.

In some embodiments, a non-transitory computer readable storage medium comprises instructions which, when executed by one or more hardware processors, causes performance of any of the operations described herein and/or recited in any of the claims.

Any combination of the features and functionalities described herein may be used in accordance with some embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory machine-readable media storing instructions which, when executed by one or more processors, cause:
receiving, by an expense auditing system, a plurality of expense descriptions associated with a plurality of expenses incurred by one or more employees;
determining, by the expense auditing system, a plurality of associations between the plurality of expense descriptions and a plurality of geographical locations where the plurality of expenses were incurred;
presenting, by the expense auditing system, a graphical user interface comprising:
(a) a geographical map representing the plurality of geographical locations where the plurality of expenses were incurred, and
(b) an expense auditing overlay that, based at least on the plurality of associations between the plurality of expense descriptions and the plurality of geographical locations where the plurality of expenses were incurred, visually associates the plurality of expenses with corresponding locations on the geographical map.

2. The one or more media of claim 1, further storing instructions which, when executed by one or more processors, cause:
determining, by the expense auditing system, an aggregate expense amount corresponding to a sum of two or more expenses in the plurality of expenses that were incurred by two more employees at a particular location in the plurality of locations;
wherein the expense auditing overlay visually associates the aggregate expense amount with the particular location.

3. The one or more media of claim 1, further storing instructions which, when executed by one or more processors, cause:
presenting, by the expense auditing system in the graphical user interface, an audit indicator representing an audit status of one or more expense descriptions in the plurality of expense descriptions.

4. The one or more media of claim 1, further storing instructions which, when executed by one or more processors, cause:
determining, by the expense auditing system, an average expense associated with a particular geographical location in the plurality of geographical locations;
presenting, by the expense auditing system in the graphical user interface, a comparison of the average expense with an expense in the plurality of expenses that was incurred at the particular geographical location.

5. The one or more media of claim 1, further storing instructions which, when executed by one or more processors, cause:
determining, by the expense auditing system, a plurality of times when the plurality of expenses were incurred;
presenting, by the expense auditing system in the graphical user interface, a visual timeline of the plurality of expenses based at least on the plurality of times when the plurality of expenses were incurred.

6. The one or more media of claim 5, wherein the visual timeline is user-selectable to view, in the graphical user interface, a subset of the plurality of expenses that were incurred during a subset of the plurality of times.

7. The one or more media of claim 5, wherein the graphical user interface comprises a playback feature for viewing a visual animation of the plurality of expenses being incurred over the plurality of times.

8. The one or more media of claim 7, wherein the expense auditing system is configured to pause the visual animation when the graphical user interface displays an expense that satisfies an audit trigger.

9. The one or more media of claim 1, further storing instructions which, when executed by one or more processors, cause:
determining, by the expense auditing system, a hierarchy of the plurality of expenses according to an organizational structure associated with a plurality of business units;
presenting, by the expense auditing system in the graphical user interface, a visual representation of the hierarchy of the plurality of expenses.

10. The one or more media of claim 1, further storing instructions which, when executed by one or more processors, cause:
determining, by the expense auditing system, a subset of the plurality of expense descriptions corresponding to expenses that satisfy an audit trigger;
presenting, by the expense auditing system in the graphical user interface, a filtered view of the subset of the plurality of expense descriptions corresponding to expenses that satisfy the audit trigger.

11. The one or more media of claim 10, wherein the expense auditing system is configured to prevent submission of an expense report comprising the plurality of expense descriptions until each expense description in the subset of the plurality of expense descriptions, corresponding to expenses that satisfy the audit trigger, has been manually audited.

12. The one or more media of claim 1, further storing instructions which, when executed by one or more processors, cause:
determining, by the expense auditing system, a subset of the plurality of expense descriptions corresponding to expenses that do not satisfy an audit trigger;
presenting, by the expense auditing system in the graphical user interface, a filtered view of the subset of the plurality of expense descriptions corresponding to expenses that do not satisfy the audit trigger;
presenting, by the expense auditing system in the graphical user interface, a user interface control for bulk approval of the subset of the plurality of expense descriptions corresponding to expenses that do not satisfy the audit trigger.

13. The one or more media of claim 1, further storing instructions which, when executed by one or more processors, cause:
applying, by the expense auditing system, the plurality of expense descriptions to a machine learning model configured to determining spending limits for employees;
based at least on output of the machine learning model: adjusting, by the expense auditing system, a spending limit for the one or more employees without adjusting a default spending limit;
wherein the expense auditing system adjusts the spending limit without receiving any user input corresponding to instructions to adjust the spending limit.

14. The one or more media of claim 13, wherein the expense auditing system adjusts the spending limit downward, based at least on the machine learning model detecting a pattern of expense rejections for the one or more employees.

15. The one or more media of claim 13, wherein the expense auditing system adjusts the spending limit upward, based at least on the machine learning model detecting a pattern of expense approvals for the one or more employees.

16. The one or more media of claim 1, further storing instructions which, when executed by one or more processors, cause:
presenting, by the expense auditing system in the graphical user interface, a user control for adjusting an expense limit that applies to a plurality of employees in one or more business units;
receiving, by the expense auditing system via the user control in the graphical user interface, user input comprising an instruction to adjust the expense limit.

17. The one or more media of claim 1, further storing instructions which, when executed by one or more processors, cause:
determining, by the expense auditing system, that the instruction to adjust the expense limit corresponds to decreasing the expense limit;
determining, by the expense auditing system, that one or more particular expense types in a plurality of expense types cannot be decreased as instructed;
responsive to the instruction to adjust the expense limit: decreasing the expense limit for all expense types in the plurality of expense types except the one or more expense types that cannot be decreased as instructed.

18. The one or more media of claim 1, further storing instructions which, when executed by one or more processors, cause:
presenting, by the expense auditing system in the graphical user interface, a user control for modifying an expense category that applies to a plurality of employees in one or more business units;
receiving, by the expense auditing system via the user control in the graphical user interface, user input comprising an instruction to modify the expense category;
modifying, by the expense auditing system responsive to the user input, the expense category.

19. A system comprising:
at least one device including a hardware processor;
the system being configured to perform operations comprising:
receiving, by an expense auditing system, a plurality of expense descriptions associated with a plurality of expenses incurred by one or more employees;
determining, by the expense auditing system, a plurality of associations between the plurality of expense descriptions and a plurality of geographical locations where the plurality of expenses were incurred;
presenting, by the expense auditing system, a graphical user interface comprising:
(a) a geographical map representing the plurality of geographical locations where the plurality of expenses were incurred, and
(b) an expense auditing overlay that, based at least on the plurality of associations between the plurality of expense descriptions and the plurality of geographical locations where the plurality of expenses were incurred, visually associates the plurality of expenses with corresponding locations on the geographical map.

20. A method comprising:
receiving, by an expense auditing system, a plurality of expense descriptions associated with a plurality of expenses incurred by one or more employees;
determining, by the expense auditing system, a plurality of associations between the plurality of expense descriptions and a plurality of geographical locations where the plurality of expenses were incurred;
presenting, by the expense auditing system, a graphical user interface comprising:
(a) a geographical map representing the plurality of geographical locations where the plurality of expenses were incurred, and
(b) an expense auditing overlay that, based at least on the plurality of associations between the plurality of expense descriptions and the plurality of geographical locations where the plurality of expenses were incurred, visually associates the plurality of expenses with corresponding locations on the geographical map,
wherein the method is performed by at least one device comprising a hardware processor.
